(19) United States
(12) Patent Application Publication
(10) Pub. No.: US 2005/0265232 A1
(43) Pub. Date: Dec. 1, 2005

(54) Mutual link system, information processing device, mutual link method, and program

(75) Inventor: Kota Tanabe, Nagoya (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawaski (JP)

(21) Appl. No.: 11/126,280

(22) Filed: May 11, 2005

Related U.S. Application Data
(63) Continuation of application No. PCT/JP03/06018, filed on May 14, 2003.

(51) Int. Cl. H04L 1/00

(52) U.S. Cl. 370/228

(57) ABSTRACT

A mutual link system for acquiring information using a personal network mutual link is provided. The mutual link system includes a communication network, plural communication devices connected to the communication network, a registration part for registering link information consisting of at least a part of communication destinations and communication devices registered in a communication destination list of each of the communication devices, and a mutual link processing part connected to the communication network and having a search control part for conducting information search with respect to link information registered in the registration part when an information search request is issued by one of the communication devices.

### CROSS REFERENCE TO RELATED APPLICATIONS

This application is a U.S. continuation application filed under 35 USC 111(a) claiming benefit under 35 USC 120 and 365(c) of PCT application JP2003/006018, filed on May 14, 2003, the entire contents of which are hereby incorporated by reference.

### BACKGROUND OF THE INVENTION

1. Field of the Invention

The present invention relates generally to a data network and particularly to a personal network mutual link system and method using communication devices.

2. Description of the Related Art

Conventionally, a user of an information network such as the Internet may access a website having a search function in order to acquire information existing within the network in an effective manner.

In such a case, typically, the user provides a keyword corresponding to or associated with the desired information to the website with the search function, and in response, the website with the search function extracts pertinent information out of a vast range of information and presents the extracted information. Then, the user sorts through the extracted information to obtain the desired information.

FIG. 1 is a diagram illustrating a configuration of an information network system according to the prior art. The information network system 100 of FIG. 1 includes a client 101 corresponding to a personal computer, a portable information terminal, or a mobile phone, for example, that is primarily operated by a user, the Internet 102, a web server (or application) 103, and a database server 104.

In the following, operations executed within the information network system 100 when the user conducts information search are described.

First, the client 101 conducting the information search accesses the web server 103 via the Internet 102.

Then, the client 101 inputs a keyword that corresponds to a search request for the desired information, and the keyword is transmitted to the Internet 102 as is indicated by arrow 110. Then, the keyword is transmitted to the web server 103 via the Internet 102 as is indicated by arrow 111.

Then, the web server 103 sends a search request to the database server 104, as is indicated by arrow 112, based on the keyword transmitted from the client 101. In turn, the database server 104 conducts information search according to the keyword.

Then, the web server 103 receives a search result of the information search from the database server 104, as is indicated by arrow 113.

Then, the web server 103 generates a web page indicating the search result according to the search result from the database server 104. Then, the web server 103 transmits the generated web page to the client 101 via the Internet 102, as is indicated by arrow 114.

Then, the client 101 receives the web page indicating the search result from the web server 103 via the Internet 102, as is indicated by arrow 115.

Then, the client 101 sorts through the information presented in the web page indicating the search result. The client 101 repetitively conducts the above-described operation to acquire satisfactory information.

However, it is noted that in recent years and continuing, the amount of information contained within the Internet is dramatically increasing, and it is becoming difficult for a user to acquire desired information in an efficient manner.

In the following, exemplary problems that may be encountered by an Internet user upon attempting to gain access to information provided within the Internet under the above-described circumstance are described.

A first problem is that the amount of information presented in the web page indicating the search result may be extremely large so that the user may not be able to sort through the presented information to obtain the desired information in an efficient manner. In other words, it may take a long time before the user reaches the desired information.

A second problem is that the intellectual level of the information being presented in the web page indicating the search result may not always be in accordance with the knowledge level of the user. Accordingly, information that is already known by the user or information with a low intellectual level may be provided, thereby degrading the efficiency in the information search.

A third problem is that the information presented by the web page indicating the search result may include undesired information that the user does not wish know. For example, hyperlinked information of the web page may include information content that may be upsetting or slanderous to the user, but the user may not know the actual content of the information until accessing the information.

A fourth problem is that the credibility of the information presented in the web page indicating the search result cannot be determined. In other words, the credibility of the presented information cannot be guaranteed, and even when the presented information is obviously wrong, there is no way for the user to recognize the inaccuracy of the information.

A fifth problem is that the web page indicating the search result may only be capable of presenting information that corresponds with the input information (keyword). For example, if ‘car’ is input as the keyword, although information items corresponding to the keyword such as ‘auto car’ and ‘two-wheeled car’ may be searched out and presented in the search result, information associated with words such as ‘engine’ or ‘tire’ may not be searched out and presented based on the keyword ‘car’.

It is noted that prior art techniques relating to the present invention are disclosed in Japanese Laid-Open Patent Publication No. 7-192009, Japanese Laid-Open Patent Publication No. 2002-56011, Japanese Laid-Open Patent Publication No. 5-265677, and Japanese Laid-Open Patent Publication No. 4-14177, for example.

### SUMMARY OF THE INVENTION

The present invention has been conceived in view of one or more of the problems of the related art, and its object is to provide a mutual link system and a mutual link method for enabling high speed acquisition of information in an efficient manner.

According to an aspect of the present invention, a mobile terminal (phone) corresponding to a communication device is used to realize a mutual link system/method.

The mobile terminal is being widely used nowadays by the general population. It is noted that the mobile terminal has previously been regarded as one means for realizing oral communication between plural persons (i.e., word-of-mouth communication). A large portion of mobile terminals presently being used are provided with a variety of functions including a personal network such as an address book corresponding to a list of telephone numbers, e-mail addresses, and other information of plural persons.

It is noted that each address book of each mobile terminal is unique to its corresponding owner (user), and each mobile terminal may be perceived as having a unique network that is defined by its address book.

The unique network of each mobile terminal corresponds to a private network, and is generally not disclosed outside.

According to an aspect of the present invention, plural unique networks that are defined by the respective address books of plural owners (users) of mobile terminals (corresponding to link information and referred to as ‘personal network’ hereinafter) are integrated to enlarge the personal network into an integrated network (referred to as ‘personal network mutual link system’ hereinafter). It is noted that the process of integrating the personal networks is referred to as ‘mutual linking’. Link information corresponds to information associating an owner of a mobile terminal with its communication counterpart.

Also, according to an aspect of the present invention, the mobile terminal may register information pertaining to a personal network with which it wishes to establish a mutual link (referred to as ‘establishing friendship’ hereinafter). In this way, information may be passed on and sorted through in an efficient manner.

According to an aspect of the present invention, a mutual link system is provided that includes a communication network, plural communication devices connected to the communication network, a registration part for registering link information consisting of at least a part of communication destinations and communication devices registered in a communication destination list of each of the communication devices, and a mutual link processing part connected to the communication network and having a search control part for conducting information search with respect to link information registered in the registration part when an information search request is issued by one of the communication devices.

According to aspects of the present invention, the first through fifth problems of the related art described above may be resolved as described below.

With respect to the first problem, by registering a certain personal network as a mutual link counterpart (for establishing friendship), the source of information being output in response to a search may be designated, and websites subject to the search may be reduced so that the amount of output information may be controlled. Accordingly, the amount of unnecessary information displayed as a search result may be reduced, and an information user may acquire desired information in an efficient manner.

With respect to the second problem, in registering a certain personal network as a mutual link counterpart (for establishing friendship), an information provider with a high knowledge level may be set so that unnecessary information may be prevented from being displayed as a search result and new (unknown) information and information with intellectual level may be efficiently acquired.

With respect to the third problem, in registering a certain personal network as a mutual link counterpart (for establishing friendship), an information provider with high credibility may be set to prevent accessing of harmful information.

With respect to the fourth problem, in registering a certain personal network as a mutual link counterpart (for establishing friendship), an information provider with high credibility may be set so that inaccurate information may be prevented from being displayed as a search result.

With respect to the fifth problem, by designating category information to be used in the information search, and tracking down information providers of which personal networks are mutually linked to one another (mutually establishing friendship with one another), advanced information may be acquired compared to a case of merely inputting information such as a keyword.

According to an aspect of the present invention, an information user may use a personal network mutual link system to efficiently and swiftly acquire information according to his/her knowledge level.

### BRIEF DESCRIPTION OF THE DRAWINGS

FIG. 1 is a diagram showing a configuration of an information network system according to the prior art;

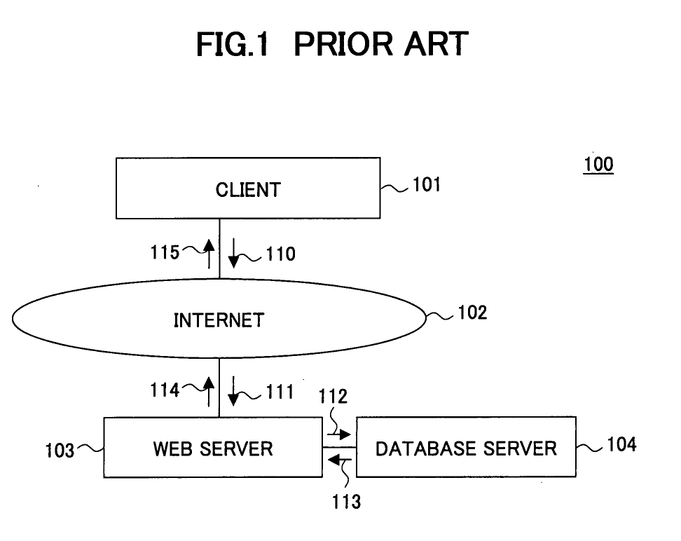

FIG. 2 is a diagram showing a configuration of an information network system including a personal network mutual link system according to a first embodiment of the present invention;

FIG. 3 is a flowchart illustrating a personal network registration operation that is conducted by an information provider according to the first embodiment;

FIG. 4 is a diagram showing a configuration of an information network system including a personal network mutual link system according to a second embodiment of the present invention;

FIG. 5 is a diagram showing a configuration of an information network system including a personal network mutual link system according to a third embodiment of the present invention;

FIG. 6 is a diagram showing a configuration of an information network system including a personal network mutual link system according to a fourth embodiment of the present invention;

FIG. 7 is a diagram showing an exemplary configuration of a search input display screen according to a fifth embodiment of the present invention;

FIG. 8 is a diagram showing an exemplary configuration of a search result display screen that is displayed after a search is conducted according to the fifth embodiment;

FIG. 9 is a diagram showing an exemplary configuration of a search input display screen according to a sixth embodiment of the present invention;

FIG. 10 is a diagram showing an exemplary configuration of a search input display screen that is displayed after the search input display screen of FIG. 9 according to the sixth embodiment;

FIG. 11 is a diagram showing an exemplary configuration of a search result display screen that is displayed after a search is conducted according to the sixth embodiment;

FIG. 12 is a diagram showing an exemplary configuration of a registration display screen according to a seventh embodiment of the present invention; and

FIG. 13 is a diagram showing a data configuration of a personal network mutual link server according to an eighth embodiment of the present invention.

### DESCRIPTION OF THE PREFERRED EMBODIMENTS

In the following, preferred embodiments of the present invention are described with reference to the accompanying drawings.

It is noted that according to an embodiment of the present invention, plural unique networks that are defined by the respective address books (i.e., list of communication addresses) of plural mobile terminals (corresponding to link information and referred to as ‘personal network’ hereinafter) are integrated to enlarge the personal network into an integrated network (referred to as ‘personal network mutual link system’ hereinafter) The process of integrating the personal networks is referred to as ‘mutual linking’, and the link information (personal network) corresponds to information linking the owner (user) of the corresponding mobile terminal to a communication counterpart.

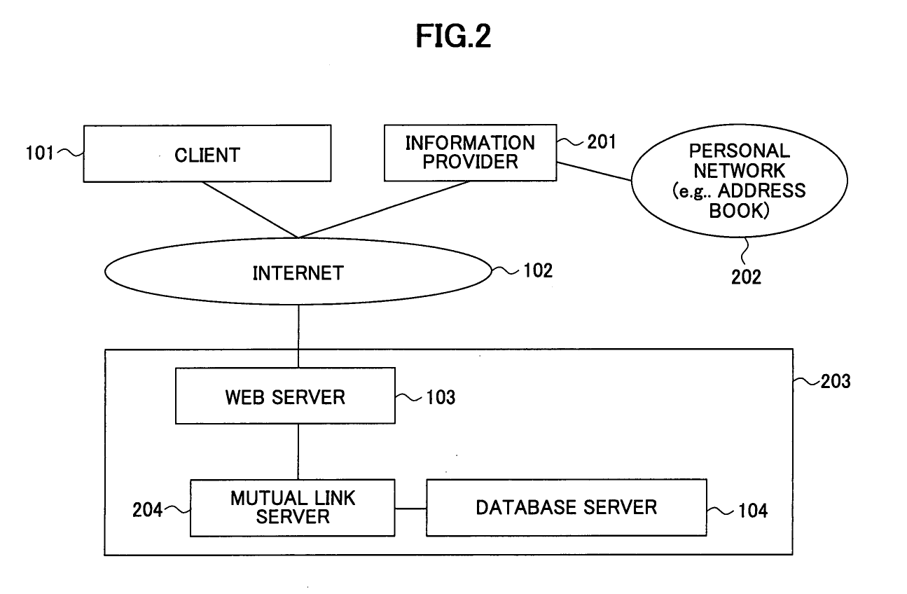

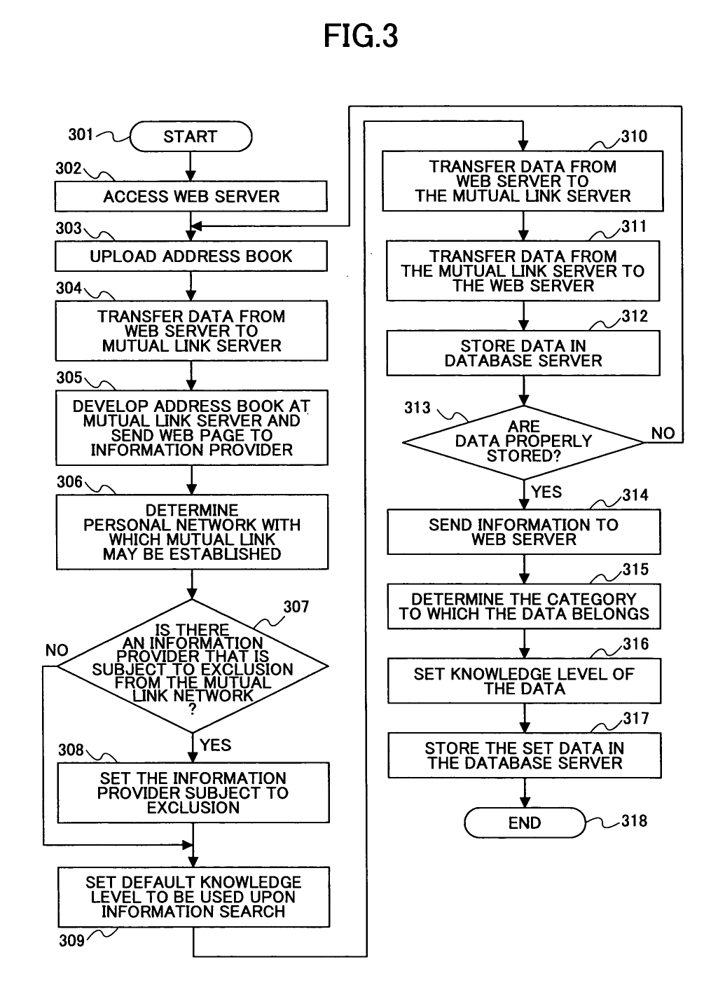

In the following, a first embodiment of the present invention is described with reference to FIGS. 2 and 3.

In the first embodiment, an information provider conducts registration operations using a personal network mutual link system.

FIG. 2 is a diagram showing a configuration of an information network system including a personal network mutual link system according to the present embodiment. The information network system shown in FIG. 2 includes a client 101, the Internet 102, an information provider 201, a personal network 202, and a personal network mutual link system 203. The personal network link system 203 includes a web server 103, a personal network mutual link server 204, and a database server 104.

FIG. 3 is a flowchart illustrating a process flow of registration operations conducted by the information provider 201 using the personal network mutual link system 203.

According to FIG. 3, first, in step 301, the registration process is started.

Then, in step 302, the information provider 201 accesses the web server 103.

Then, in step 303, the information provider 201 uploads the personal network 202 corresponding to a unique network defined by an address book, for example, to the web server 103.

Then, in step 304, the web server 103 forwards the data uploaded in step 303 to the personal network mutual link server 204.

Then, in step 305, the personal network mutual link server 204 develops the address book, generates a web page based on a list of addresses in the developed address book, and transmits the generated web page to the information provider 201.

Then, in step 306, the information provider 201 sorts information in the web page generated based on the list of addresses that is transmitted in step 305, and determines the personal network with which it wishes to establish a mutual link (establish friendship), and transmits the determination information to the web server 103.

Then, in step 307, it is determined whether there is an information provider to be excluded from the personal network mutual link system 203. In a case where it is determined that an information provider to be excluded does exist, the process moves on to step 308, and in a case where it is determined that an information provider to be excluded does not exist, the process moves on to step 309.

In step 308, the information provider to be excluded from the personal network mutual link system 203 is set.

Then, in step 309, a default knowledge level of the information provider 201 that is used upon conducting information search is set.

Then, in step 310, the web server 103 forwards data representing the determinations made in steps 306 through 309 to the personal network mutual link server 204.

Then, in step 311, the personal network mutual link server 204 transmits the data uploaded in step 303 and the data representing the determinations made in steps 306 through 309 to the database server 104.

Then, in step 312, the database server 104 stores the data transmitted in step 311.

Then, in step 313, a determination is made as to whether data are stored in the database server 104. In a case where it is determined that the data are not stored in the database server 104, the process goes back to step 303, and the registration process is repeated. In a case where it is determined that the data are stored in the database server 104, the registration process by the information provider 201 is ended, and the process moves on to step 314.

In step 314, the information provider 201 transmits information it wishes to provide to the web server 103.

Then, in step 315, a category to which the data provided by the information provider 201 in step 314 belongs is set.

Then, in step 316, a knowledge level of the data provided by the information provider 201 in step 314 is set.

Then, in step 317, the data provided in step 314 and the data set in steps S315 and S316 are stored in the database server 104 in a manner such that the provider of the data may be identified.

Then, in step 318, the information providing operation by the information provider is ended.

As is described above, according to the present embodiment, registration of the information provider 201 and registration of information provided by the information provider 201 to the personal network mutual link system 203 are conducted.

In the following, a second embodiment of the present invention is described. The second embodiment relates to information search operations conducted by the information provider using the personal network mutual link system 203. In the example described below, it is assumed that the information being searched is stored in the database server 104.

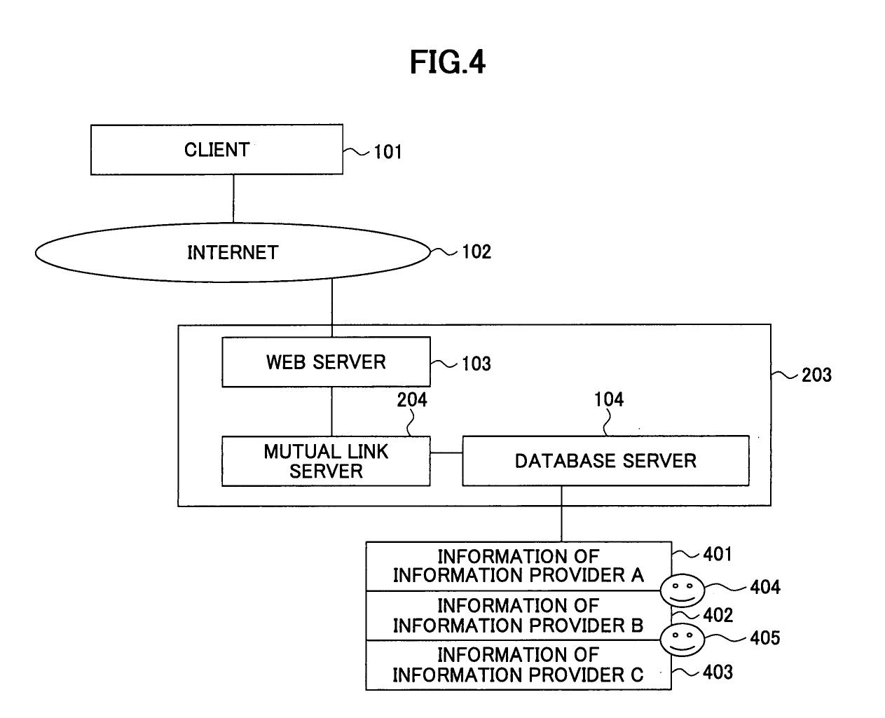

FIG. 4 is a diagram showing a configuration of an information network system including a personal network link system according to the second embodiment.

The information network system of FIG. 4 includes a client 101, the Internet 102, and a personal network mutual link system 203. The personal network mutual link system 203 includes a web server 103, a personal network mutual link server 204, and a database server 104. Also, three information providers are connected the information network system of FIG. 4, the information providers being referred to as information providers A, B, and C, respectively. It is noted that the information providers A, B, and C may correspond to the information provider 201 that is described in relation to the first embodiment. Also, it is noted that a mutual link is established between a personal network of the client 101 and the personal network of the information provider A in a manner as is described above in relation to the first embodiment (i.e., friendship is established between the personal networks). A mutual link is established between the personal network of the information provider A and the personal network of the information provider B in the manner as is described above in relation to the first embodiment. A mutual link is established between the personal network of the information provider B and the personal network of the information provider C in the manner as is described above in relation to the first embodiment.

The information providers A, B, and C provide information 401, 402, and 403, respectively, that are stored in the database server 104. Since a mutual link is established between the information providers A and B, the information 401 of the information provider A and the information 402 of the information provider B may be mutually searched as is indicated by the friendship mark 404. Also, since a mutual link is established between the information provider B and the information provider C, the information 402 of information provider B and the information 403 of the information provider C may be mutually searched as is indicated by the friendship mark 405.

In the following, a process flow of information search operations conducted by an information user using the personal network mutual link system 203 according to the second embodiment is described.

First, the information provider accesses the web server 103.

Then, the client 101 inputs the knowledge level of information being searched.

Then, the client 101 inputs the corresponding category information of the information being searched.

Then, the client 101 uses the personal network mutual link system 203 to input information designating the information provider of the information to be searched out and acquired.

Then, the client 101 inputs a keyword associated with desired information to be searched, and transmits the keyword to the web server 103.

Then, the web server 103 uses the input keyword to search for information out of information that is provided by the information provider designated by the input information, belongs to the same category as the input category, and is assigned the same knowledge level as the input knowledge level.

Then, the client 101 tracks down information 401, 402, and 403 of the information providers A, B, and C that establish mutual links with the client 101, and repeats the search step as is described above. Since the client establishes a mutual link with the information provider A, it is capable of searching the information 401 of the information provider A. Since the information provider A establishes a mutual link with the information provider B, the information 401 of the information provider A and the information 402 of the information provider B may be mutually searched. Since the information provider B establishes a mutual link with the information provider C, the information 402 of the information provider B and the information 403 of the information provider C may be mutually searched. Thus, the client 101 is also capable of searching the information 402 of the information provider C.

Then, the web server 103 generates a web page based on a search result transmitted from the database server 104 and the information used in the search step as is described above, and transmits the generated web page indicating the search result to the information user (client 101).

In this way, the information user may conduct information search using the personal network mutual link system 203.

In the following, a third embodiment of the present invention is described. The third embodiment relates to information search operations conducted by an information provider using the personal network mutual link system 203 in a case where information to be searched is stored within a personal computer of an information provider corresponding to a communication device.

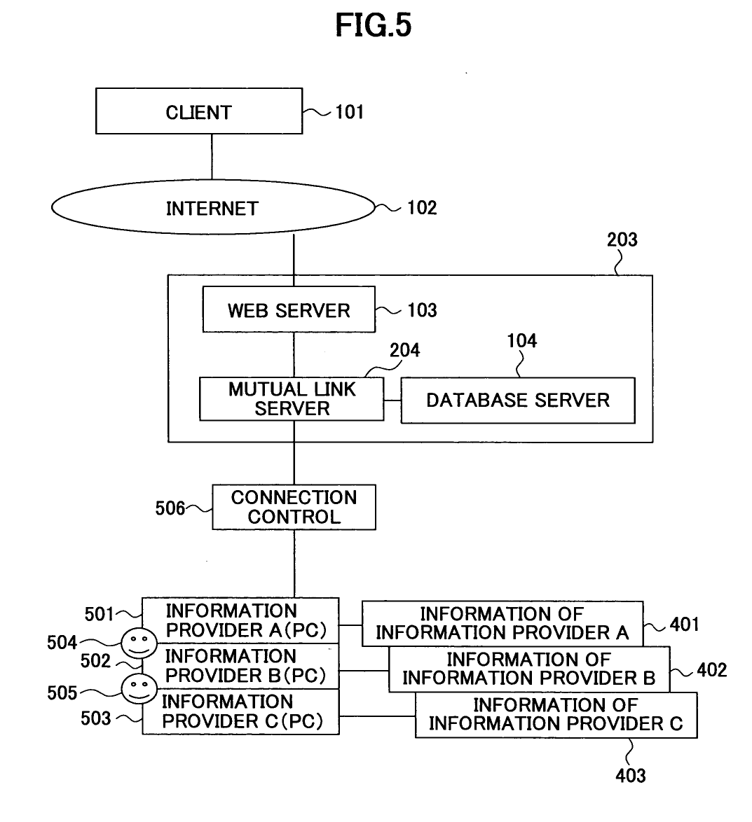

FIG. 5 is a diagram showing a configuration of an information network system including a personal network mutual link system according to the third embodiment. The information network system of FIG. 5 includes a client 101, the Internet 102, and a personal network mutual link system 203. The personal network mutual link system 203 includes a web server 103, a personal network mutual link server 204, and a database server 104. Also, according to the present embodiment, three information providers A, B, and C are connected to the information network system. It is noted that the information providers A, B, and C may correspond to the information provider 201 as is described in relation to the first embodiment. It is noted that a mutual link is established between a personal network of the client 101 and the personal network of the information provider A in a manner as is described above in relation to the first embodiment (i.e., friendship is established between the personal networks). A mutual link is established between the personal network of the information provider A and the personal network of the information provider B in the manner as is described above in relation to the first embodiment. A mutual link is established between the personal network of the information provider B and the personal network of the information provider C in the manner as is described above in relation to the first embodiment. Also, connection control 506 of a personal computer 501 of the information provider A, the personal computer 502 of the information provider B, and the personal computer 503 of the information provider C is conducted by the personal network mutual link server 204.

It is noted that the information providers A, B, and C provide information 410, 402, and 403, respectively. In the third embodiment, the information 401, 402, and 403 of the information providers A, B, and C are respectively stored in the personal computers 501, 502, and 503 of the information providers A, B, and C. As is described above, the information providers A and B are mutually linked, and thereby, the information 401 of the information provider A and the information 402 of the information provider B may be mutually searched via the personal computers 501 and 502 as is indicated by the friendship mark 504. Also, the information providers B and C are mutually linked, and thereby, the information 402 of the information provider B and the information 403 of the information provider C may be mutually searched via the personal computers 502 and 503 as is indicated by the friendship mark 505.

In the following, process steps are described for realizing the information search operations using the personal network mutual link system according to the third embodiment.

First, the information user accesses the web server 103.

Then, the client 101 inputs a knowledge level of the information to be searched.

Then, the client 101 inputs category information of the information to be searched.

Then, the client 101 inputs information designating the information provider of the information to be searched and acquired using the personal network mutual link system, 203.

Then, the client inputs a keyword associated with the desired information to be searched, and transmits the keyword to the web server 103.

Then, the personal network mutual link server 204 conducts connection control 506 between the personal computers 501 of the information provider A, the personal computers 502 of the information provider B, the personal computers 503 of the information provider C, and the client 101.

Then, the personal network mutual link server 204 conducts information search with respect to information stored in the personal computers 501, 502, and 503 using the input keyword. In this case, the information search is conducted with respect to information that is provided by the information designated by the input information, belongs to the same category as the input category, and is assigned the same knowledge level as the input knowledge level.

Then, the personal network mutual link server 204 transmits a search result of the information search to the web server 103.

Then, the web server 103 generates a web page based on the search result transmitted from the personal network mutual link server 204, and transmits the generated web page to the information user (client 101) via the Internet 102.

In this way, the information user may conduct information search using the personal network mutual link system 203.

In the following, a fourth embodiment of the present invention is described. The fourth embodiment relates to information search operations conducted by an information user using the personal network mutual link system 203. Specifically, the fourth embodiment relates to a search method implemented in a case where the information to be searched is stored in a personal computer of an information provider, and the personal network mutual link server 204 conducts connection control such that the client 101 may be individually connected to each personal computer of each information provider through peer-to-peer connection.

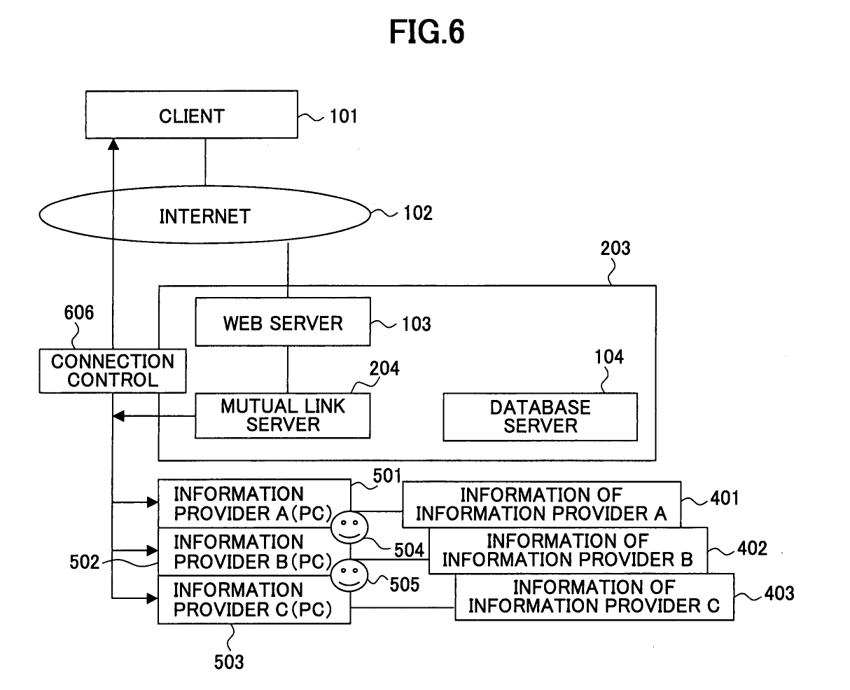

FIG. 6 is a diagram showing a configuration of an information network system including a personal network mutual link system according the fourth embodiment. The information network system of FIG. 6 includes a client 101, the Internet 102, and a personal network mutual link system 203. The personal network mutual link system 203 includes a web server 103, a personal network mutual link server 204, and a database server 104. Also, according to the present embodiment, three information providers A, B, and C are connected to the information network system. It is noted that the information providers A, B, and C may correspond to the information provider 201 as is described in relation to the first embodiment. It is noted that a mutual link is established between a personal network of the client 101 and the personal network of the information provider A in a manner as is described above in relation to the first embodiment (i.e., friendship is established between the personal networks). A mutual link is established between the personal network of the information provider A and the personal network of the information provider B in the manner as is described above in relation to the first embodiment. A mutual link is established between the personal network of the information provider B and the personal network of the information provider C in the manner as is described above in relation to the first embodiment. Also, connection control 606 of a personal computer 501 of the information provider A, the personal computer 502 of the information provider B, and the personal computer 503 of the information provider C is conducted by the personal network mutual link server 204.

It is noted that the information providers A, B, and C provide information 410, 402, and 403, respectively. In the fourth embodiment, the information 401, 402, and 403 of the information providers A, B, and C are stored in the personal computers 501, 502, and 503 of the information providers A, B, and C, respectively. As is described above, the information providers A and B are mutually linked, and thereby, the information 401 of the information provider A and the information 402 of the information provider B may be mutually searched via the personal computers 501 and 502 as is indicated by the friendship mark 504. Also, the information providers B and C are mutually linked, and thereby, the information 402 of the information provider B and the information 403 of the information provider C may be mutually searched via the personal computers 502 and 503 as is indicated by the friendship mark 505.

In the following, process steps are described for realizing the information search operations using the personal network mutual link system 203 according to the fourth embodiment.

First, the information user accesses the web server 103 via the client 101.

Then, the information user inputs information designating an information provider that is to conduct information search via the client 101 using the personal network mutual link system 203, and transmits the input information to the web server 103.

Then, the personal network mutual link server 204 transmits to the client 101 a list of information providers that are mutually linked based on pre-registered security information.

Then, the user selects an information provider (out of information providers A, B, and C) to which connection is to be established via the client 101, and transmits a connection request to the personal network mutual link server 204 for establishing connection with the personal computer of the selected information provider.

Then, the personal network mutual link server 204 establishes peer-to-peer connection between the client 101 and the personal computer of the selected information provider according to the connection request.

Then, the information user gathers information from the peer-to-peer connected personal computer of the selected information provider after the connection is established.

The information user changes the connection destination (i.e., personal computer) and repeats the process steps of sending a connection request and establishing peer-to-peer connection with the designated personal computer until obtaining the desired information.

In this way, the information user may conduct information search using the personal network mutual link system 203.

In the following, a fifth embodiment of the present invention is described. The fifth embodiment relates to a search input display screen for conducting information search, and a search result display screen indicating the search result of the information search that may be displayed by the web server 103 upon conducting the information search operations according to the second or third embodiment.

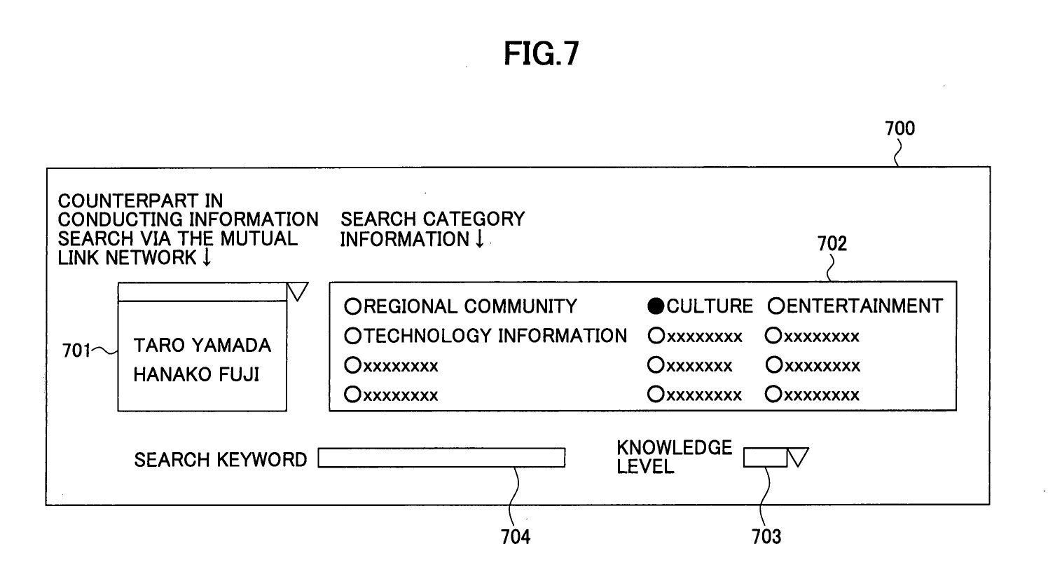

FIG. 7 is a diagram illustrating an exemplary search input display screen of the present embodiment that is displayed by the web server 103. The search input display screen shown in FIG. 7 includes in information provider input part 701 for selecting and inputting the information provider that is to conduct the information search using the personal network mutual link system 203, a category input part 702 for selecting and inputting search category information, a knowledge level input part 703, and a search keyword input part 704. Information search as is described in relation to the second or third embodiment may be conducted by inputting predetermined information in the input parts 701 through 704.

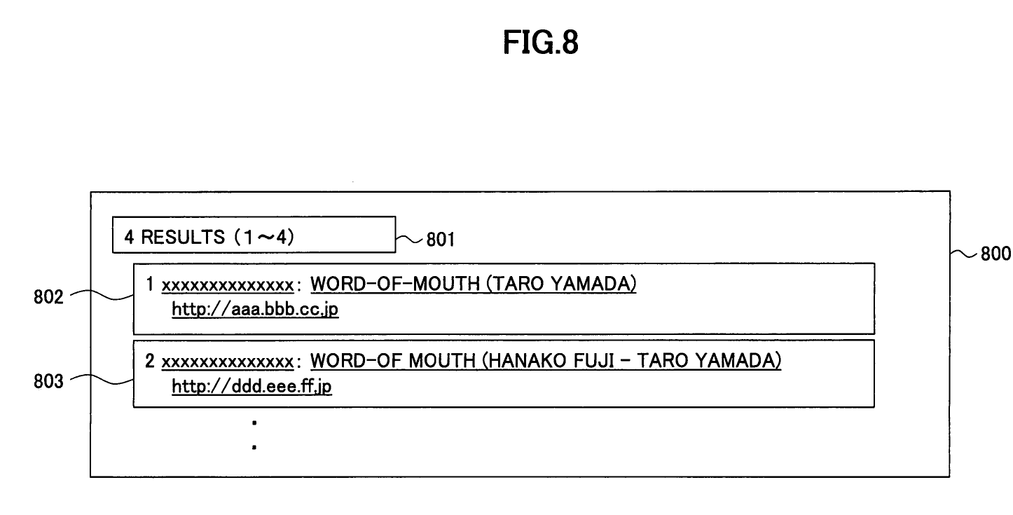

FIG. 8 is a diagram illustrating an exemplary search result display screen according to the present embodiment that is displayed by the web server 103 after information search is conducted. The search result display screen of FIG. 8 includes a total search result display part 801 indicating the total number of matches extracted from the information search, item display parts 802 and 803 displaying the individual searched items. In the illustrated example of FIG. 8, the display part 801 indicates that a total of four matches (search results) have been extracted by the information search, and the display parts 802 and 803 representing the individual search results indicate information on the search conditions and address information such as URL (uniform resource locator) of the extracted information.

In the following, a sixth embodiment of the present invention is described. The sixth embodiment relates to search input display screens and a search result display screen that are displayed by the web server 103 upon conducting the search operation according to the fourth embodiment in which the client 101 is connected to a personal computer of an information provider through peer-to-peer connection.

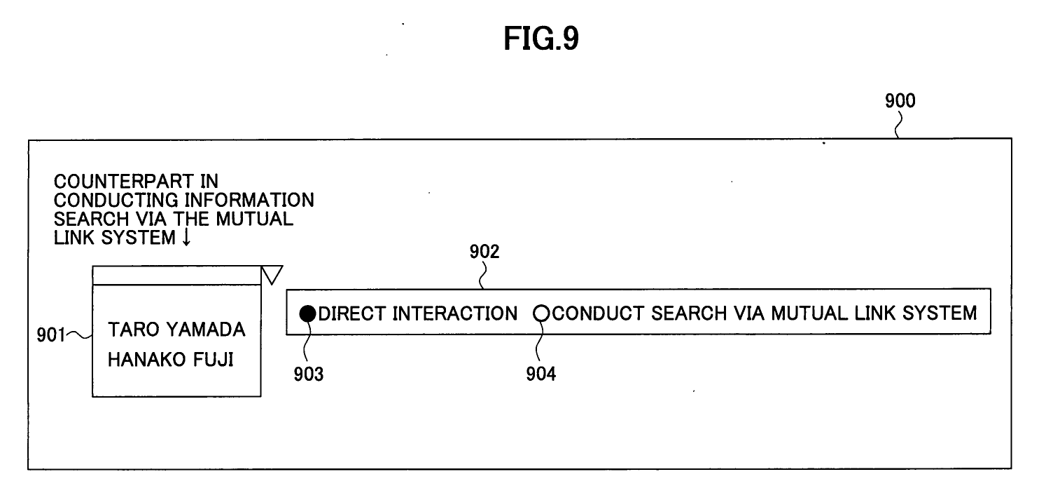

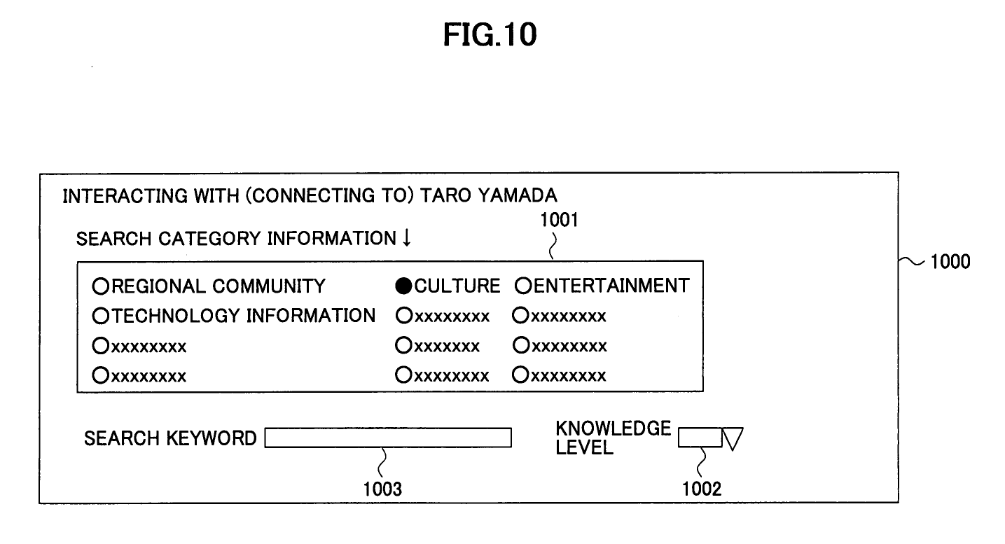

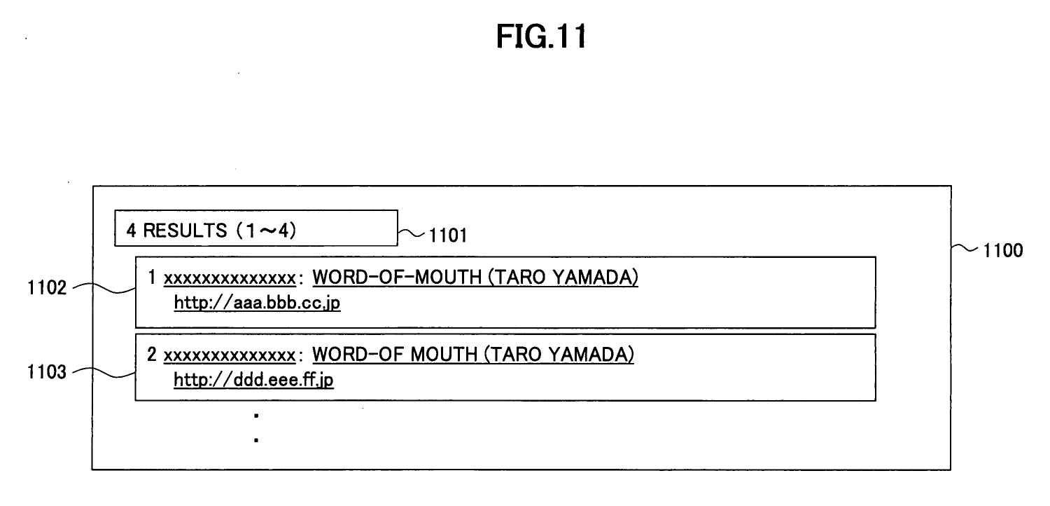

FIG. 9 is a diagram illustrating an exemplary configuration of a search input display screen that is displayed by the web server 103 according to the sixth embodiment. FIG. 10 is a diagram illustrating an exemplary configuration of a search input display screen that is displayed by the web server 103 or the personal computer of the information provider connected to the web server 103 through peer-to-peer connection after the search input display screen of FIG. 9 is displayed. FIG. 11 is a diagram illustrating an exemplary configuration of a search result display screen that is displayed by the web server 103 of the personal computer of the information provider according to the sixth embodiment.

The search input display screen 900 of FIG. 9 includes an information provider input part 901 for selecting and inputting an information provider that is to conduct information search via the mutual link system and a selection input part 902 for selecting a method of interacting with the selected information provider. The selection input part 902 further includes a button 903 for designating direct interaction with the selected information provider and another button 904 for designating the mutual link system to conduct the information search.

The search input screen 1000 of FIG. 10 includes a category input part 1001 for inputting or selecting search category information, a knowledge level input part 1002, and a search keyword input part 1003.

By inputting predetermined information to the information provider input part 901 and the selection input part of FIG. 9, and the category input part 1001, the knowledge level input part 1002, and the search keyword input part 1003 of FIG. 10, the information search operation according to the fourth embodiment may be conducted. It is noted that when the selection button 903 for designating direct interaction with the selected information provider is selected a the search input display screen 900 of FIG. 9, the search input display screen 1000 of FIG. 10 may be generated and displayed at the personal computer of the selected information provider connected through peer-to-peer connection with the client 101.

The search result display screen 1100 of FIG. 11 that is displayed after the information search input includes a total results display part 1101, and individual item display parts 1102 and 1103 that indicate the respective searched items from the information search. In the illustrated example of FIG. 11, the total results display part 1101 indicates that a total of four results have been extracted from an information search operation, and the individual item display parts 102 and 103 represent the search conditions and the address information such as URL (uniform resource locator) of the extracted information.

In the following, a seventh embodiment of the present invention is described. The seventh embodiment of the present invention relates to a registration display screen that is displayed by the web server 103 when an information provider conducts a registration operation according to the first embodiment of the present invention.

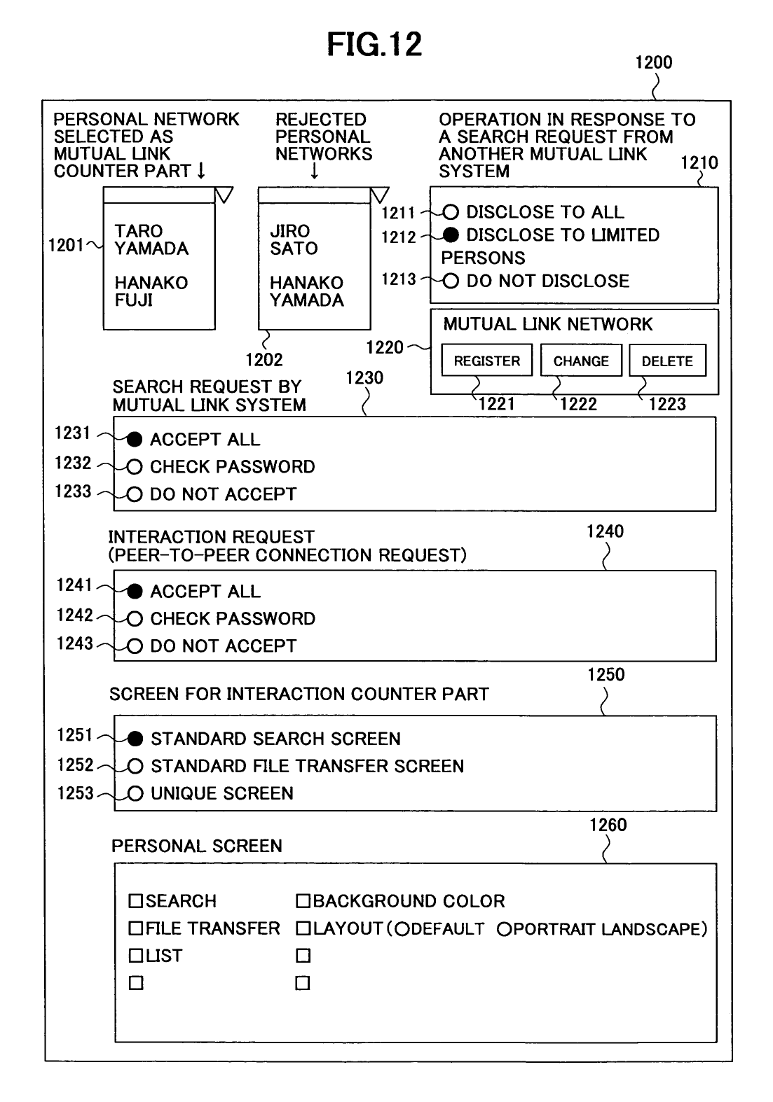

FIG. 12 is a diagram showing an exemplary configuration of a registration display screen that is displayed by the web server 103 according to the seventh embodiment. The registration display screen 1200 of FIG. 12 includes a selection input part 1201 for selecting a personal network with which a mutual link is to be established, a selection input unit 1202 for selecting a personal network with which mutual linking is to be rejected, an operation selection unit 1210 for selecting an operation to be conducted in response to a search request that is issued by another mutual link system, a registration operation selection part 1220, an operation selection part 1230 for selecting an operation to be conducted in response to a search request issued by the mutual link system being used, an operation selection part 1240 for selecting an operation to be conducted in response to an interaction request (request for establishing peer-to-peer connection), a screen selection part 1250 for selecting the screen to be displayed at the terminal issuing the connection request (interaction destination), and a personal screen part 1260.

The operation selection part 1210 for selecting an operation to be conducted in response to a search request from another mutual link system includes a selection button 1211 for selecting an operation of disclosing information to any given information user, a selection button 1212 for selecting an operation of disclosing information only to designated information users, and an operation selection button for selecting an operation of abstaining from disclosing information to any information user.

The operation selection part 1230 for selecting an operation to be conducted in response to a search request from the present mutual link system includes an operation selection button 1231 for selecting an operation of accepting any given search request from the mutual link system, an operation selection button for selecting an operation of selecting a search request after conducting password confirmation, and an operation selection button 1233 for selecting an operation of abstaining from accepting any search request.

The selection part 1240 for selecting an operation to be conducted in a case where an interaction request, namely, a peer-to-peer connection request, is issued includes an operation selection button 1241 for selecting an operation of accepting any given interaction request, an operation selection button 1242 for selecting an operation of accepting an interaction request after conducting password confirmation, and an operation selection button 1243 for selecting an operation of abstaining from accepting any interaction request.

The screen selection part 1250 for selecting the screen to be displayed at the terminal issuing the connection request includes a button 1251 for designating the display of a standard search screen, a button 1252 for designating the display of a standard file transfer screen, and a button 1253 for designating the display of a unique screen.

The personal screen part 1260 includes buttons for directing a search, a file transfer, generating a list, and selecting a background color or layout of the screen, for example.

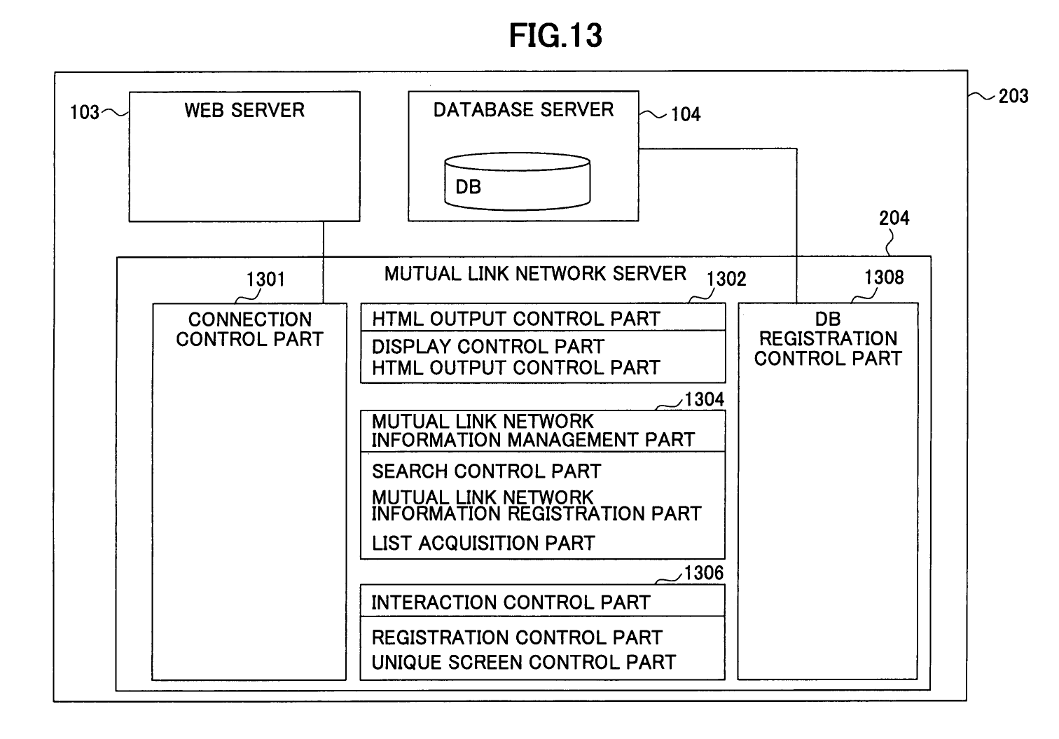

In the following, an eighth embodiment of the present invention is described. The eighth embodiment relates to a data configuration of the personal network mutual link server 204. FIG. 13 is a diagram illustrating a configuration of a mutual link system according to the eighth embodiment. According to this drawing, the mutual link system according 203 includes a web server 103, a database server 104, and a personal network mutual link system 204. The personal network mutual link system 204 includes a connection control part 1301, an HTML output control part (hypertext markup language) 1302, a mutual link information management part 1304, an interaction control part 1306, and a database registration control part 1308. The HTML output control part 1302 includes a display control part and an HTML output part, and is configured to display a web page described using HTML.

The mutual link information management part 1304 includes a search control part, a mutual link information registration control part, and a list acquisition part, and is configured to conduct the operations according to the first through fourth embodiments.

The interaction control part 1306 includes a registration control part and a unique screen control part, and is configured to conduct the connection control operation that is described above in relation to the fourth embodiment.

The database registration control part 1308 is configured to control the data storage operation of the database server 104.

Further, it is noted that the present invention is not limited to the specific embodiments described above, and variations and modifications may be made without departing from the scope of the present invention.

1. A mutual link system comprising:
a communication network;
a plurality of communication devices that are connected to the communication network;
a registration part for registering link information consisting of at least a part of communication destinations and communication devices registered in a communication destination list of each of the communication devices; and
a mutual link processing part connected to the communication network and having a search control part for conducting information search with respect to link information registered in the registration part when an information search request is issued by one of the communication devices.

2. The mutual link system as claimed in claim 1, wherein the mutual link processing part controls an operation of registering the link information of the registration part.

3. The mutual link system as claimed in claim 1, wherein the registration part registers information provided by the communication destination included in the link information.

4. The mutual link system as claimed in claim 3, wherein the registration part registers information pertaining to a provider, a knowledge level, and a category of the provided information, along with the provided information.

5. The mutual link system as claimed in claim 3, wherein the search control part conducts information search with respect to the provided information registered in the registration part when an information search request is issued from one of the communication devices.

6. The mutual link system as claimed in claim 1, wherein the search control part includes an input part for inputting at least one of a provider, a knowledge level, a category, and a password of the provided information, and is configured to conduct information search according to the at least one of the provider, the knowledge level, the category, and the password of the provided information.

7. The mutual link system as claimed in claim 1, wherein the search control part is configured to control connection between one of the communication devices and the communication destination registered in the registration part in a manner such that information search is conducted with respect to information of the communication destination registered in the registration part when an information search request is issued from one of the communication devices.

8. The mutual link system as claimed in claim 1, wherein the search control part is configured to realize one-to-one connection between one of the communication devices and the communication destination registered in the registration part when an information search request is issued from one of the communication devices.

9. A personal network mutual link method, comprising:
a registration step of registering link information consisting of at least a part of communication destinations and communication devices registered in a communication destination list of each of a plurality of communication devices connected to a communication network; and
a mutual link processing step including a search control step of conducting information search with respect to link information registered in the registration step when an information search request is issued by one of the communication devices.

10. The mutual link method as claimed in claim 9, wherein the mutual link processing step includes controlling an operation of registering the link information of the registration step.

11. The mutual link method as claimed in claim 9, wherein the registration step includes registering information provided by the communication destination included in the link information.

12. The mutual link method as claimed in claim 11, wherein the registration step includes registering information pertaining to a provider, a knowledge level, and a category of the provided information, along with the provided information.

13. The mutual link method as claimed in claim 9, wherein the search control part includes an input step for inputting at least one of a provider, a knowledge level, a category, and a password of the provided information, and a step of conducting information search according to the at least one of the provider, the knowledge level, the category, and the password of the provided information.

14. An information providing apparatus comprising:
a registration part for registering link information consisting of at least a part of communication destinations and communication devices registered in a communication destination list of each of a plurality of communication devices connected to a communication network; and
a mutual link processing part connected to the communication network and having a search control part for conducting information search with respect to link information registered in the registration part when an information search request is issued by one of the communication devices.

15. The information providing apparatus as claimed in claim 14, wherein the mutual link processing part controls an operation of registering the link information of the registration part.

16. The information providing apparatus as claimed in claim 14, wherein the registration part registers information provided by the communication destination included in the link information.

17. The information providing apparatus as claimed in claim 16, wherein the registration part registers information pertaining to a provider, a knowledge level, and a category of the provided information, along with the provided information.

18. The information providing apparatus as claimed in claim 16, wherein the search control part conducts information search with respect to the provided information registered in the registration part when an information search request is issued from one of the communication devices.

19. The information providing apparatus as claimed in claim 14, wherein the search control part includes an input part for inputting at least one of a provider, a knowledge level, a category, and a password of the provided information, and is configured to conduct information search according to the at least one of the provider, the knowledge level, the category, and the password of the provided information.

20. The information providing apparatus as claimed in claim 14, wherein the search control part controls connection between one of the communication devices and the communication destination registered in the registration part in a manner such that information search is conducted with respect to information of the communication destination registered in the registration part when an information search request is issued from one of the communication devices.
